(19) United States
(12) Patent Application Publication
(10) Pub. No.: US 2011/0097159 A1
(43) Pub. Date: Apr. 28, 2011

(54) TUBING CONDUIT SYSTEM, A METHOD FOR CONTROL THEREOF AND THE USE THEREOF

(76) Inventor: Johann Haberl, Skarholmen (SE)

(21) Appl. No.: 12/865,070

(22) PCT Filed: Jan. 27, 2009
(86) PCT No.: PCT/SE09/00031

§ 371 Date: Dec. 17, 2010

(30) Foreign Application Priority Data
Jan. 28, 2008 (SE) 0800206-5

(51) Int. Cl. B65G 53/66

(52) U.S. Cl. 406/15

(57) ABSTRACT

The invention comprises a tubing conduit system for transport of solid or liquid material with a transport air stream, which is driven by at least one vacuum source (1) driven by an electric driving motor (2) and comprises at least one closable feeding opening (8) for transport air and transported material, characterized in that the system is arranged to make possible control of the power delivered by the driving motor as a function of the transport air flow, so that the power at a low transport air flow value below an upper transport air flow limit value of a lower transport air flow range is maintained below an upper limit value within a lower power range, and the power at a high transport air flow exceeding a lower transport air flow limit value for a higher transport air flow range is maintained above a lower limit value for a higher power range, wherein the upper limit value of the lower power range amounts to at most 80% of the lower limit value of the higher power range, and a method for controlling this tubing system.

This invention comprises a tubing system (tubing conduit plant) for the transport of solid, liquid and/or gaseous materials with a transporting gas stream acting as a transporting medium, also denoted transport gas stream or flow, preferably for transport of solid and/or liquid materials with a stream of air, also denoted transport air stream or flow, and the use and control of this system.

The invention according to this patent application claims priority from the Swedish patent application SE0800206-5 with filing date Jan. 28, 2008, and everything disclosed in this older patent application is a part of the present specification.

Such tubing systems are commonly used e.g. in commercial buildings, such as industries, for removing wastes and collecting this waste for removal or further treatment. Such systems usually comprise at least one vacuum source (sub-atmospheric pressure source, suction source), at least one driving motor for this source and at least one tubing conduit connected to this source and is provided with one or more closable feeding openings (extraction openings) for feeding of the material which shall be transported in the tubing conduit, which are distributed along the length of the conduit. Usually there is also at least one separation means for the transported material arranged between the vacuum source and the tubing conduit.

The tubing system is usually constructed from communicating parts. These parts may comprise parts of different types, such as essentially straight, elongated, usually circular-cylindrical tubes, tube bends, e.g., 30, 45 and 90 degrees bends, branch pipes with connection of 3 or more tubing conduit parts of the same or different dimensions, conical connecting parts for tubing parts of different dimensions (cross section size and shape) and also other vessels of varying shape and dimension, such as settling chambers, wet cleaning device (scrubber), filter chamber, cyclone separator and similar. The material in the various parts of the system can be selected from e.g. metals, such as steel, stainless steel, cast iron, aluminum and Al-alloys, plastics, elastomers, such as rubber materials, and similar. Parts of different materials can be combined, e.g. tube bends and branch pipes of plastics, elastomers and/or metal and tubes of plastics, elastomers and/or metal. Common tubing diameters in such plants are e.g. 50 mm, 76 mm and 108 mm with variation limits of up to plus/minus 10% or 20%. Air velocities in such plants, especially in the tubing conduits, such as transport air velocity during the working periods of the system, are often in average at least 10, at least 15 or at least 20 meters/second up to 30 meters/second or more, within at least a part of, and optionally at least 50% of the tubing conduit where transport work is carried out.

Usually air from the surrounding atmosphere is used as the transporting gas, i.e. transport air, and an air flow is achieved with a vacuum source. This type of system plants will be described below, but this invention can also be used with systems which work with over-atmospheric pressure and also with other gases than air as transporting medium.

The system thus comprises one or more feeding or extraction points or openings for feeding the material which shall be transported and transport air. The system may comprise one single elongated tubing conduit with one or more feeding points distributed along the length of the conduit, or two or more, e.g. 3, 4, 5 or more connected in parallel, especially communicating tubing conduit sections, each with one or more feeding points distributed along each tubing conduit section. The feeding points are suitably closable openings and may also comprise flexible hoses connected to these openings, and the inlet openings of these hoses may be open or closable, forming feeding points for the transported material and also for transport air. Usually the tubing conduit, or tubing conduit sections together, or at least one of the tubing conduit sections comprises at least 5, at least 10 or at least 20 and often up to 10, up to 30, up to 50 or more feeding points, usually with transport air inlet.

In many such systems the transport load often varies with time, and since the energy (power) consumption for driving the vacuum (sub-atmospheric pressure) source is a large cost, there is a need for being able to adapt the power (effect) output of the driving motor to the amount of transportation needed (the quantity of transported material) and the magnitude of the transport air flow/air stream and the magnitude of the vacuum (sub-atmospheric pressure) required. To achieve this is difficult, especially with systems with long tubing conduits or a large number of feeding points with transport air inlets.

The transporting transport air stream is achieved with a vacuum source (sub-atmospheric pressure source), which reduces the pressure in the system to below the pressure in the surrounding, usually the atmospheric pressure. The vacuum (sub-atmospheric pressure) source can be of arbitrary type, e.g. a fan, a piston pump, e.g. of rotating piston type, such as a root-compressor, a membrane pump or a centrifugal pump or a Turbopump (™). One suitable vacuum (sub-atmospheric) pressure source is a Turbopump of lateral channels type which is available from Dustcontrol AB, Sweden. Examples of such Turbopumps are those with the Dustcontrol designations “Tubopump TED 2,5 kW”, “Tubopump TED 5 kW”, “Tubopump TPD 9,2 kW” and “Tubopump TSD 9,2 kW”. These usually have a normal working pressure range between about 12 and 30 kPa. The vacuum sources may also be distinguished with regard to how the power needed for driving the vacuum source varies with the amount of air passing through the vacuum source and the pressure drop (pressure difference) between its inlet and outlet. Examples of vacuum sources where the power demand can drop with an increase of the air flow/mass flow and simultaneous reduction of the pressure difference between inlet and outlet are piston pumps, root-compressors and similar, especially such which work with constant or essentially constant stroke volume. One or more such like or different vacuum sources with the same or different capacity can be used in the same system.

The vacuum source or sources are driven by one or more driving motors for each vacuum source or for several such together. The driving motor is preferably electric, preferably of asynchronous or synchronous motor type, especially of single phase or three phase type. The driving motor can be constructed for one or more nominal rotational speeds, e.g. for a ratio of the highest to the lowest nominal rotational speed of 6:1, 4:1 or 2:1 or at least any of these ratios. It is also possible to use some type of gear box with fixed or variable gearing between the driving motor and the vacuum source, e.g. gear-wheels, chain or rope gear box.

According to the invention it is possible to divide the time during which the vacuum source is performing work in working periods, also denoted Mode I, during which there is a need for transportation and the vacuum source shall maintain a vacuum within a higher vacuum range with a large transport air flow, and resting periods (stand-by periods), also denoted Mode II, during which there is a small or no need for transport with small or no transport air flow, but the vacuum source nevertheless shall maintain a vacuum pressure within a lower vacuum pressure range within the system.

In some cases, such as when handling health hazardous or environment hazardous material, e.g. pharmaceutical waste material, waste material from the handling of test animals, etc. it is desirable or necessary to maintain continuously a vacuum pressure in the system which is high enough to prevent leakage to the environment. A lowest such vacuum pressure may be e.g. 1 or 5 kPa.

Besides energy saving it is a further advantage of the invention that by maintaining a low vacuum pressure at low flow it is easier to open the closure means at the feeding openings and the noise from the opening is less disturbing than at a high vacuum pressure.

According to the invention the power (effect) delivered by the driving motor is controlled, optionally together with the rotational speed of the driving motor and/or the vacuum source, and thereby the power delivered by the driving motor, to a number of, especially two, from each other distinguished power and/or rotational speed ranges. For adaptation of the energy supply to the power needed, according to one embodiment rotational speed control of the driving motor and/or rotational speed control of the vacuum source is preferably used, usually by driving the vacuum source with the same rotational speed as the driving motor or with a rotational speed which is in a certain, especially fixed, ratio to the rotational speed of the driving motor, and/or with a controlled supply of supplementary air, especially supplied directly to the vacuum source or immediately before this, usually between a separation means and the vacuum source. It is usually suitable that the power delivered by the driving motor and/or the rotational speed in an idle (stand-by) state, such as with no or a low transport air flow within a low transport air flow range, is within a lower power (effect) or rotational speed range resp, the upper limit of which is at most 80%, at most 70%, at most 50% or at most 40% of the lower limit of a power or rotational speed range, within which the power or rotational speed is maintained in the working state of the plant with a transport air flow within a certain higher flow range. The control is then preferably based on the magnitude of the transport air flow and/or the vacuum pressure in the system, preferably within the part of the system which comprises feeding openings for transported material and transport air and before optional openings for introducing supplementary (auxiliary) air, especially for reducing the inlet pressure of the vacuum source and thereby the power needed.

The rotational speed control can preferably be based on frequency control of the frequency of the alternating current supplied to the driving motor. This frequency can with suitable means be controlled infinitely variable, but it is usually suitable to combine the means for frequency transformation or frequency control with control means which control the frequency/rotational speed between certain defined frequencies, preferably to a low frequency or to a low frequency range, which gives a certain lower vacuum in the idle (stand-by) state when the system is not in the working state or performs work in a lower degree for transporting solid or liquid material, and a higher frequency range or a higher frequency, preferably continuously variable, which is sufficient for a certain desired lowest transport air flow (flow velocity, weight or volume per unit of time) and/or a certain desired vacuum at a working state with such a transport. Example is e.g. about 15 Hz (herts) as a lower frequency at an idle state and e.g. from 25 up to 60 or 70 Hz at a working state. As an example of equipment for frequency control the frequency transformer Mitsubishi P700 and as an example of equipment for control of the frequency transformation a PLC-device of the type Siemens S7200 may be mentioned.

The combination of frequency/rotational speed of the driving motor and/or vacuum source and/or supplied driving power and/or vacuum which are used in the idle state or working state respectively is suitably adapted so that the upper limit of the range of the values in question in the idle state, or the particular value thereof which is used in the idle state, is at most 80%, or at most 50% or at most 30% of the lower limit of the range of the value in question which is maintained in the working state. For the rotational speed this may usually be at most 25 Hz, at most 20 Hz, at most 10 Hz in the idle state, and for the working state usually at least 15 Hz, at least 20 Hz, at least 30 Hz or at least 40 Hz for the lower limit of the value in question in the working state. This is especially true at the net frequency 50 Hz and/or driving motors adapted for this frequency. At a higher net frequency, e.g. 60 Hz the mentioned limits of the rotational speed and frequency can usually be increased in proportion to the increase of the net frequency and/or the nominal frequency of the driving motors.

For control, managing and survey of a tubing system according to the invention sensors are used which intermittently or continuously measure one or more parameters in the system, preferably selected from pressure, transport air flow/flow velocity, flow of transported material, supplementary air flow and temperature. Usually it is desired to maintain in the working state, Mode I, a vacuum exceeding a certain minimum working vacuum value within the entire system or the system before the separation means and/or vacuum source and/or supplementary air inlet point. The pressure measurement can be performed at several points preferably also, in the flow direction counted, after the feeding point or transport air inlet point which is closest to the vacuum source or separation means, which also can be used as reference pressure measuring point, or before the supplementary air inlet point. Experience shows that this pressure, or the pressure at some other point or points can be selected and controlled so that simultaneously a sufficiently high vacuum is maintained within the entire or parts of the system. The working state, i.e. the state when transport shall be performed with a transport air stream, can be indicated by measuring the transport air flow/flow velocity in the system, e.g. after the feeding point or inlet point for air closest to the vacuum source or separation means or at a filter before the vacuum source, e.g. by measuring the pressure drop (difference pressure measuring) through a filter or a choke flange, and/or flow measuring, e.g. with a hot body gauge. The idle state, Mode II, can be indicated by a transport air flow/flow velocity below a certain value, which can be down to zero if there is no leakage of transport air into the system. It may be suitable that the system is arranged to change at the occurrence of such a low air flow from working with a high rotational speed/driving power to working with a low rotational speed/driving power, i.e. change to the idle state, Mode II.

When using the system with power control and/or frequency control of the operation of the vacuum source a flow/stream velocity gauge is preferably used for a decision if the system shall be operated in the working state or in the idle state. When the transport air flow/stream velocity exceeds a certain minimum value, the frequency control is operated for maintaining the vacuum in the system above a certain value by control of the power or rotational speed of the driving motor, Mode I. When the flow/stream velocity is below a certain value the power or rotational speed of the driving motor is controlled by power control or frequency control so that the pressure in the system, the idle pressure, is maintained at a value within a lower range, Mode II, than the working pressure.

The transition from the idle state to the working state can be indicated and initiated by a decrease of the pressure below the idle state range, which is a consequence of an inlet of air into the system upstream a pressure gauge. Control of the driving motor power, and/or frequency for increasing the rotational speed, and for thereby increasing the vacuum to the working pressure level can be performed immediately or with a certain time delay for avoiding rapid variations up and down of the pressure and frequency/rotational speed. The delay can be achieved by simultaneous control with a slowly reacting flow/stream gauge, preferably of the hot body type (hot wire type). Examples of other flow gauges are pressure difference gauges, which measure the pressure drop over a certain distance of flow, and pitot tubes.

The vacuum source is cooled with an air flow, but in some cases when the system is in the working state, Mode I, but the air flow is low, the air flow may be insufficient for keeping the temperature of the vacuum source below a desired maximum value. For avoiding this the temperature of the vacuum source may be surveyed and an increase of the air flow and/or a reduction of the power and/or of the rotational speed/frequency, optionally with transition to the idle state, Mode II, performed until the temperature sinks below a selected limit value. The temperature measuring can suitably comprise the temperature of the bearings or the rotating axis of the vacuum source, and an upper limit may be e.g. at most 130 or at most 100° C.

This invention comprises also a method for supervising and controlling the pressure in a tubing system for transport of solid, liquid and/or gaseous material with a transport gas stream, preferably a transport air stream, preferably of solid and/or liquid materials with a transport air stream. This method comprises preferably measuring the pressure at more than one point in the system, such as 2, 3, 4, or more points, and calculating an average of these measured values, preferably a weighted average, where pressure values at various points can be weighted or multiplied with different factors depending on the position of the measuring point and optionally other factors. The calculation of the average is suitably performed with a computer. It may be suitable that at least one of the pressure gauges is arranged after the last feeding opening before the separation means or the vacuum source in the direction of the flow. For simplifying the control it is possible to use only one pressure gauge, preferably arranged after the last feeding opening before the separation means. For simplifying the maintenance of a sufficient vacuum within an entire system with long tubing conduits and/or many requested feeding points it may also be suitable to divide the tubing system into a number of parallel tubing semi-conduits or branch tubings, each of which has a shorter length extension and/or fewer number of feeding openings, which together give the required number of feeding openings.

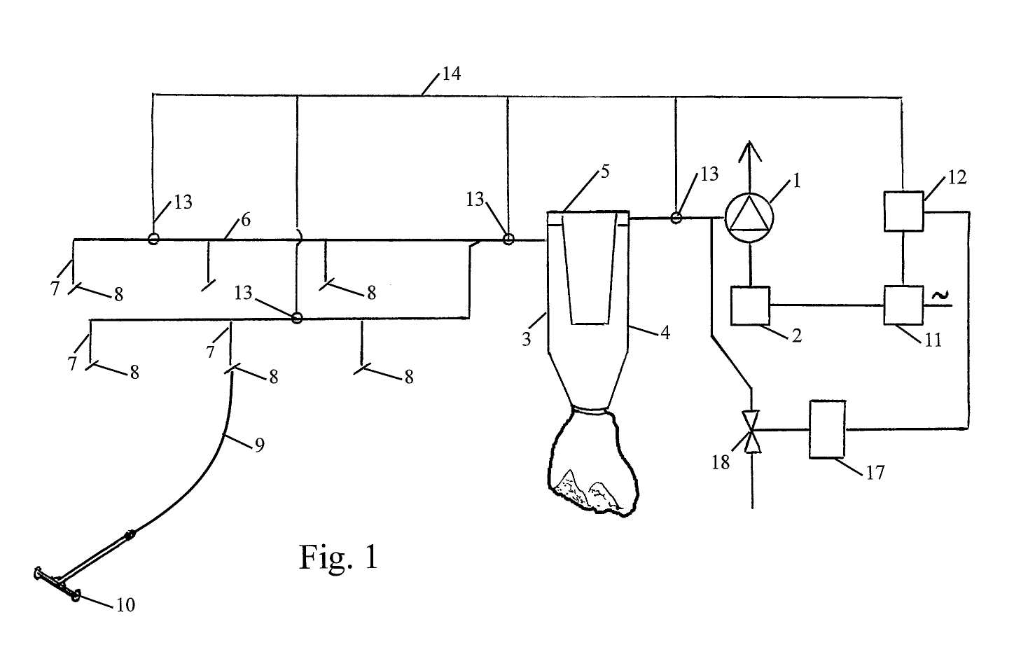

In the enclosed drawings FIG. 1 shows schematic a plant according to the invention. This plant comprises a vacuum source 1, which is driven by an electric motor 2. The vacuum source 1 is connected to a separation means 3 comprising a pre-separator consisting of a cyclone separator 4 and a filter unit 5 arranged after the separator in the flow direction. Extending from the separation means 3 a tubing conduit 6 is arranged with a number of branch tubings 7, and at their ends are arranged closable feeding openings 8 for material which shall be transported and for simultaneous inlet of transport air. A hose 9 is shown connected with one end to one of the feeding openings, and at the other end a feeding opening 10 is arranged. From a number of gauges 13 at various points in the system, such as in the tubing conduit 6 and between the separation means and the vacuum source, information is transferred, e.g. such as through wirings 14 or in other ways, concerning values which are essential for the operation of the system, such as, preferably, at least one of the vacuum, the air flow, especially transport air flow, the flow of transported material, preferably at least the vacuum and the air flow/transport air flow, to a control unit 12, which preferably is arranged for computer based calculation and control operations. From the control unit 12 control signals can be sent to an electricity control unit 11 for the electric current sent to the electric motor 2, preferably alternating current, and/or a control means 17 for the supplementary air, which controls a supplementary air valve 18, which suitably is arranged for controlled supply of supplementary air to the vacuum source 1 after the separation means 3. The electrical control unit 11 and/or supplementary air control means 17 nay also be integrated into the control unit 12. The power delivered by the driving motor and its rotational speed and thereby the rotational speed of the vacuum source can suitably be controlled with the frequency of the supplied alternating current, using a frequency transformer, which can transform a supplied net frequency, usually 50 or 60 Hz, to a frequency supplied to the motor, which can be selected within a range below and/or above the net frequency, for controlling the power delivered by the driving motor. The transformed frequency may e.g. be from 5 or 10 Hz up to 15 or 20 Hz within a lower frequency range and e.g. from 15, 20, 25 or 30 Hz up to e.g. 50, 60 or 70 Hz or above within a higher frequency range. Controlled supply of supplementary air is preferably used when the vacuum source comprises a piston pump or a similar device, which has lower power consumption at a larger air flow and lower inlet pressure and lower pressure drop between the air inlet and outlet, but a controlled supply of supplementary air can also be used for other types of vacuum sources.

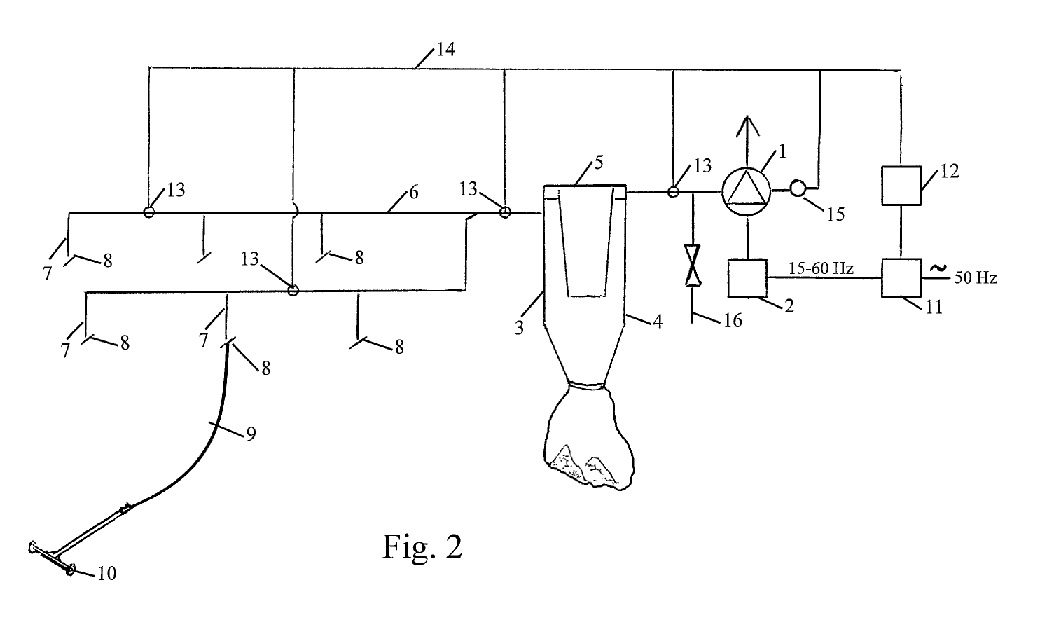

FIG. 2 shows in more detail a plant according to the invention similar to that according to FIG. 1, comprising a vacuum source 1, which consists of a rope driven air pump made by Dustcontrol (™) of the type IPR 40 which is driven by an asynchrony motor 2 with the nominal power 15 kW at the frequency 50 Hz. The vacuum source 1 is connected to a separation means 3 comprising a pre-separator consisting of a cyclone separator 4 and after this in the flow direction arranged filter unit 5. From the separation means 3 extends a tubing conduit 6 with a number of branch tubings 7 and at the ends of these there are arranged closable feeding openings 8 for material which shall be transported and for simultaneous inlet of transport air. To one of the feeding openings a hose 9 is connected with one end, and at the other end a feeding opening 10 is arranged. The power delivered by the driving motor and its rotational speed and thereby the rotational speed of the vacuum source are controlled with the frequency of the supplied alternating current, the frequency of which is controlled to between 15 and 60 Hz with a frequency transformer 11 of the type Mitsubishi F700, to which is supplied a current with the frequency 50 Hz and which is controlled with a PLC-device 12 of the type Siemens TP7200. The PLC-device 12 is supplied with information concerning the vacuum and the flow in the plant from a number of gauges 13 at various points in the system, such as in the tubing conduit 6 and between the separation means and the vacuum source. From the gauges 13 the measured values are sent through a wiring 14 to the PLC device 12. After tuning it was possible to control the plant for maintaining a sufficient vacuum in the system with measured values from only one gauge, preferably a pressure gauge arranged after the last feeding opening 13 before the separation means 3. At the vacuum source there is also a temperature gauge 15 which is connected to the PLC device 12 for preventing overheating of the vacuum source. Before the vacuum source there is also a so called vacuum valve 16 which permits separate inlet of air, e.g. for cooling the vacuum source.

This plant was operated with a frequency of 15 Hz and a vacuum in the tubing conduit 6 of 4 kPa in the idle state in the absence of or at low air flow caused by air leakage, and a frequency of 40-60 Hz in the working state with a high flow rate for maintaining a vacuum of about 20 kPa in the tubing conduit. The plant was used for transport of waste in a production factory. The same type of plant was also used in animal housings and at construction sites for removal of waste in connection with new construction, repair or demolition.

The vacuum in tubing conduits in plants according to the invention is often at most 20, at most 10 or at most 5 kPa in the idle state. In the working state the corresponding pressure usually may be at least 15, at least 20, at least 25 or at least 40 kPa., e.g. 18-24 kPa, within the entire tubing conduit or close to the feeding point which is arranged nearest to the vacuum source or separation means. In some plants the vacuum source is kept in constant operation, e.g. when handling hazardous, especially health hazardous materials, for preventing leakage of these. I other plants the vacuum source may be kept out of operation when the plant is not in the working state or idle state.

A system according to the invention can be arranged for rotational speed control of the driving motor and the vacuum source driven by it, e.g. as a function of the air flow, so that the rotational speed at a low air flow value below an upper limit is kept below an upper limit value within a lower rotational speed range, and the rotational speed at a high air flow above a lower limit value is kept above a lower limit value within a higher rotational speed range, wherein the upper limit value of the lower rotational speed range amounts to at most 80% and preferably at most 50% of the lower limit value of the higher rotational speed range. The system can be arranged for control of the rotational speed of the driving motor and the vacuum sources through frequency control of the electric current supplied to the driving motor, preferably to at most 15 Hz within the lower and at least 20 Hz within the higher rotational speed range resp. Furthermore, this system may comprise pressure gauges for measuring the vacuum in the system, connected to control means for control of the rotational speed of the driving motor, which makes it possible to maintain a vacuum within selected limit values by control of the rotational speed of the driving motor within the higher rotational speed range. Furthermore, the system may comprise means which in an operation state within the lower rotational speed range at a decrease of the vacuum or air flow from a value normal for the state to a certain lower value, are arranged to start the transition to the higher rotational speed range, and/or at a decrease of the air flow below a predetermined limit value are arranged to start the transition to the lower rotational speed range This system may furthermore be operated with a control method which is characterized by measuring with at least one flow gauge the air flow and/or by measuring with at least one pressure gauge the vacuum in the system and feeding these values to a control unit for the driving motor, which control unit controls the rotational speed of the driving motor and the vacuum source to values within at least two from each other separated rotational speed ranges, wherein when the air flow exceeds a certain minimum value, which indicates air inlet into the tubing conduit, by control of the rotational speed of the driving motor to within a higher rotational speed range, a higher vacuum is maintained in the system, and when the air flow is below a minimum value, by control of the rotational speed of the driving motor to within a lower rotational speed range maintains a lower vacuum in the system, wherein the upper limit value of the lower rotational speed range is at most 80% and preferably at most 50% of the lower limit value of the higher rotational speed range. The control of the rotational speed of the driving motor and the vacuum source may be achieved by frequency control of the frequency of the alternating current Vs supplied to the driving motor, preferably to at most 15 Hz within the lower and to at least 20 Hz within the higher rotational speed range. Hereby it is possible to maintained by rotational speed control at a low air flow a vacuum of at most 5 kPa and to maintain at high air flow a vacuum of at least 8 kPa.

The expression “vacuum” herein means a pressure which is below the pressure of the surrounding, especially below the atmospheric pressure. A “higher” vacuum thus means a lower absolute pressure, i.e. a larger pressure difference from the atmospheric pressure.

The invention can with advantage be used during the entire time of operation of a system, which preferably may mean the period of time during which a vacuum is maintained in the system, but it can also be used during only a part of this period of time, e.g. during at least 50% of the time of operation.

1. A tubing conduit system for transport of solid or liquid materials with a transport air stream, which is driven by at least one vacuum source (1) driven by an electric driving motor (2) and comprises at least one closable feeding opening (8) for transport air and transported material, characterized in that the system is arranged to make possible control of the power delivered by the driving motor as a function of the transport air flow, so that the power at a low transport air flow value below an upper transport air flow limit value of a lower transport air flow range is maintained below an upper limit value within a lower power range, and the power at a high transport air flow exceeding a lower transport air flow limit value of a higher transport air flow range is maintained above a lower limit value of a higher power range, wherein the upper limit value of the lower power range amounts to at most 80% of the lower limit value of the higher power range.

2. A tubing conduit system according to claim 1, characterized in that the system is arranged for control of the power delivered by the driving motor by controlled inlet of supplementary air, preferably after the last in the direction of the transport air stream flow arranged feeding opening for transport air and transported material, and/or control of the rotational speed of the driving motor and the vacuum source by frequency control of the electric current supplied to the driving motor, preferably to at most 15 Hz within the lower and at least 20 Hz within the higher power or rotational speed range.

3. A tubing conduit system according to claim 1 or 2, characterized in that the system comprises pressure measuring means for measuring the negative pressure in the system, and/or air flow measuring means for measuring the air flow in the system, connected to control means for control of the power delivered by the driving motor and/or the rotational speed, which makes it possible to maintain a vacuum within selected limit values at one or more feeding openings through control of the power and/or rotational speed of the driving motor within the higher power and/or rotational speed range.

4. A tubing conduit system according to any of the preceding claims, characterized in that the system comprises a close to the vacuum source arranged separation means comprising a centrifugal separator and/or filter for separation of material transported with the tubing conduit system.

5. A tubing conduit system according to any of the preceding claims, characterized in that the system comprises means which, when operating in an operation state within the lower power range, are arranged to start the transition to the higher power range at a decrease of the vacuum or increase of the transport air flow from a value normal for the state to a certain lower or higher value resp., and/or at a decrease of the transport air flow below a predetermined limit value start the transition to the lower power range.

6. A tubing conduit system according to any of the preceding claims, characterized in that the system comprises temperature measuring means arranged to measure the temperature of the driving motor and/or the vacuum source, which make possible an increase of the air flow or other measures for reducing said temperature when it exceeds a predetermined limit value.

7. A tubing conduit system according to any of the preceding claims, characterized in that the system comprises a vacuum source which exhibits a power demand which decreases with increasing air flow and decreasing pressure in the system, preferably of the types piston pump, root-compressor and similar, wherein the system is provided with inlet means for supplementary air, which are arranged to be actively controlled by the transport air flow and/or vacuum in the system.

8. A method for controlling a tubing conduit system according to any of the preceding claims for transport of solid or liquid material with a transport air stream, comprising a tubing conduit with at least one closable feeding opening for feeding transported material and transport air, a separation means for transported material, and a vacuum source with electric driving motor, characterized by controlling the power delivered by the driving motor as a function of the transport air demand to different power ranges, comprising a lower power range at a low transport air flow below an upper transport air flow limit value of a lower transport air flow range, and a higher power range at a high transport air flow exceeding a lower transport air flow limit value of a higher transport air flow range, wherein the upper limit value of the lower power range is at most 80% of the lower limit value of the higher power range, and wherein the transport air flow is measured with at least one flow measuring means and/or the vacuum in the system is measured with at least one pressure measuring means and these values are transferred to a control unit for control of the power delivered by the driving motor.

9. A method according to claim 8, characterized by controlling with the control unit the power or rotational speed of the driving motor and the vacuum source to values within at least two from each other distinguished power or rotational speed ranges, and wherein, preferably during at least 50% of the operation time of the tubing conduit system, when the transport air flow exceeds a certain minimum value, which indicates inlet of transport air into the tubing conduit, a higher vacuum is maintained in the system by controlling the power or rotational speed range of the driving motor to within a higher power or rotational speed, and, when the transport air flow is below a minimum value, maintaining a lower vacuum in the system by controlling the power or rotational speed of the driving motor to within a lower power or rotational speed range.

10. A method according to claim 8 or 9, characterized in that the upper limit value of the lower power or rotational speed range is at most 50% of the lower limit value of the higher power or rotational speed range.

11. A method according to any of claims 8 to 10, characterized in that the control of the power of the driving motor is achieved with controlled inlet of supplementary air, preferably after the feeding opening for transport air and transported material arranged last in the flow direction of the transport air, and/or frequency control of the frequency of the alternating current supplied to the driving motor, preferably to at most 15 Hz within the lower and to at least 20 Hz within the higher power or rotational speed range resp.

12. A method according to any of claims 8 to 11, characterized by measuring the temperature of the driving motor and/or the vacuum source, and if the temperature rises above a certain limit value, increasing the inlet of air into the system or taking other measures for cooling the driving motor and/or the vacuum source.

13. A method according to any of claims 8 to 12, characterized by maintaining, by the control of power or rotational speed, at one or more feeding openings for transport air and transported material, a vacuum of at most 5 kPa at a low transport air flow and a vacuum of at least 8 kPa at a high transport air flow.
